(19) United States
(12) Patent Application Publication
(10) Pub. No.: US 2009/0262715 A1
(43) Pub. Date: Oct. 22, 2009

(54) BRIDGE DEVICE AND METHOD FOR BRIDGING A WLAN TO A WWAN

(75) Inventor: JR-FU JUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,485

(22) Filed: Dec. 19, 2008

(30) Foreign Application Priority Data
Apr. 18, 2008 (CN) 200810301191.X

(51) Int. Cl. H04W 88/16

(52) U.S. Cl. 370/338

(57) ABSTRACT

A bridge device for bridging a wireless local area network (WLAN) and a plurality of wireless wide area networks (WWANs) includes a first communication port, a second communication port, a third communication port, a first media controller, a second media controller, a third media controller and a bridge module. The bridge module includes a flow controller and a data converter. The media controllers receive inbound data packets from corresponding communication ports and transmitting outbound data packets to corresponding communication ports. The flow controller controls data packet flow between the WLAN and the WWANs and records current bandwidths and utilization statuses of the WWANs, and the data converter converts between the inbound data packets and the outbound data packets accordingly.

### BACKGROUND

1. Technical Field

The disclosure relates to wireless communications, and particularly to a bridge device and method for bridging a wireless local area network (WLAN) to a wireless wide area network (WWAN).

2. Description of Related Art

Wireless communication networks include different types, such as wireless wide area network (WWAN), wireless metropolitan area network (WMAN), wireless local area network (WLAN) and wireless personal network. The WWAN, using such technologies as Global System for Mobile Communications (GSM), code division multiple access 2000 (CDMA 2000), and wideband CDMA (WCDMA), can provide subscribers wireless communications in wide areas using base stations with better mobility. In contrast, WLANs provide subscribers wireless communications in smaller areas but with a faster connection speed.

Subscribers that are indoors, such as in their offices or homes, can access the Internet at any time via the WLAN or fixed communication networks, such as an ADSL network. However, if subscribers are outdoors, for example, on buses or in trains, the subscribers cannot enjoy the fast connection speed of a WLAN since they must use a WWAN. Therefore, it is desired to amend to aforementioned problems.

### BRIEF DESCRIPTION OF THE DRAWINGS

FIG. 1 is a schematic diagram of an application environment of a bridge device.

FIG. 2 is a schematic diagram of an embodiment of a bridge device.

FIG. 3 is a flowchart illustrating a first embodiment of a method for bridging a WLAN to a WWAN.

FIG. 4 is a flowchart illustrating a second embodiment of a method for bridging a WLAN to a WWAN.

FIG. 5 is a flowchart illustrating a third embodiment of a method for bridging a WLAN to a WWAN.

### DETAILED DESCRIPTION

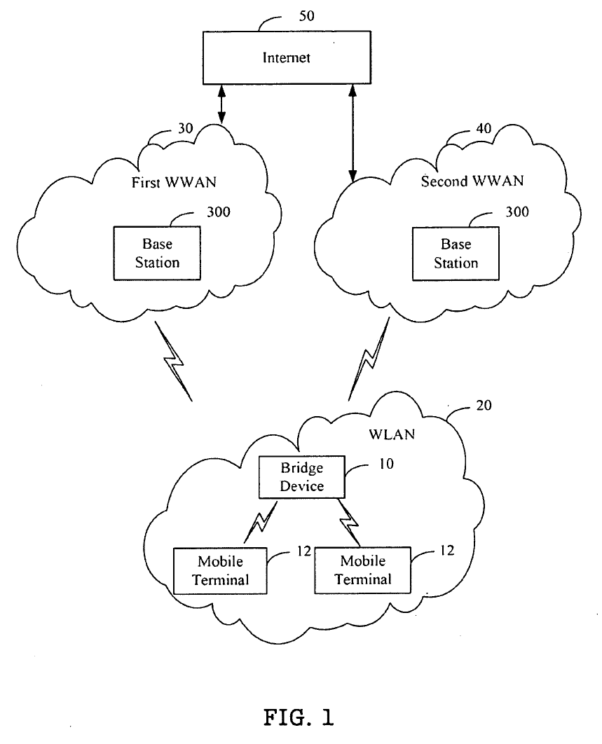

FIG. 1 is a schematic diagram of an application environment of a bridge device 10. The bridge device 10 may be configured in a “mobile” wireless local area network (WLAN) 20, for transmitting and receiving data packets as an access point (AP) of the WLAN 20. The data packets transmitted by the WLAN 20 use the Institute of Electrical and Electronics Engineers (IEEE) 802.11 a/b/g protocol. A plurality of mobile terminals 12 (only two shown in FIG. 1), which are mobile communication devices, can communicate with each other over the WLAN 20.

The bridge device 10 is used for bridging the WLAN 20 to other communication networks, such as wireless wide area networks (WWANs) 30 and 40 shown in FIG. 1. The WWANs 30 and 40 each include a plurality of base stations 300 (only one shown in FIG. 1) for communicating with the bridge device 10. Data packets transmitted by the WWANs 30 and 40 should use a specific communication protocol, such as a selected one from Global System for Mobile communications (GSM), General Packet Radio Service (GPRS), third generation (3G), wideband code division multiple access (WCDMA), and Worldwide Interoperability for Microwave Access (WiMAX). Preferably, the communication protocols employed by the first WWAN 30 and the second WWAN 40 are different. The WWANs 30 and 40 also communicate with the Internet 50. It may be appreciated that the WWANs 30 and 40 may communicate with other communication networks, such as the public switched telephone network.

Thus, the mobile terminals 12 in the WLAN 20 can communicate with the WWANs 30 and 40 via the bridge device 10 and thereby communicate with the Internet 50.

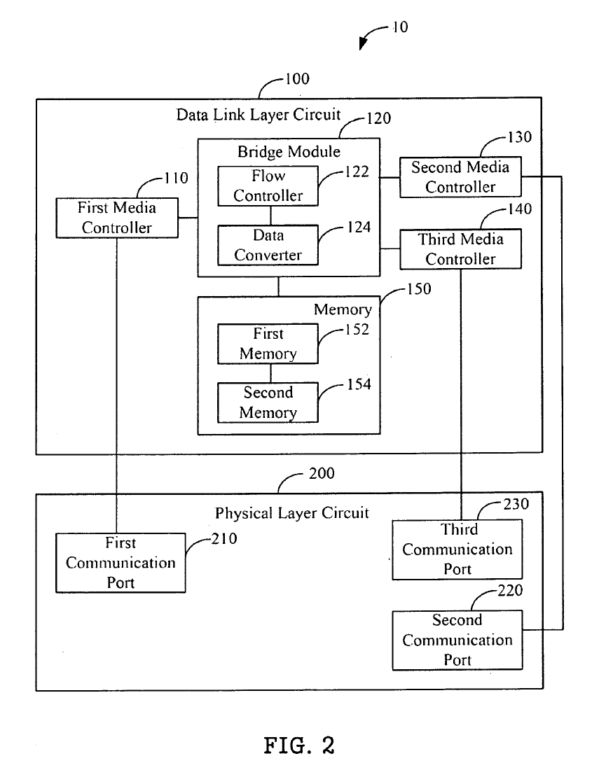

FIG. 2 is a schematic diagram of an embodiment of the bridge device 10. In one embodiment, the bridge device 10 includes a data link layer circuit 100 and a physical layer circuit 200. The physical layer circuit 200 includes a first communication port 210, a second communication port 220, and a third communication port 230. The first communication port 210 is used for receiving first inbound data packets from, and transmitting first outbound data packets to the WLAN 20. The first inbound data packets and the first outbound data packets both use the same communication protocol such as the IEEE 802.11a/b/g protocol, but may contain different content. In one embodiment, a format of the first inbound data packets and the first outbound data packets includes following fields: frame control, duration ID, address 1 (source), address 2 (destination), address 3 (rx node), sequence control, address 4 (tx node), data and FCS.

The second communication port 220 is used for receiving second inbound data packets from, and transmitting second outbound data packets to the first WWAN 30. In one embodiment, the second inbound data packets and the second outbound data packets both use the same communication protocol, such as GSM, GPRS, 3G, WCDMA or WiMAX, but may contain different content.

The third communication port 230 is used for receiving third inbound data packets from, and transmitting third outbound data packets to the second WWAN 40. In the embodiment, the third inbound data packets and the third outbound data packets both use the same communication protocol, such as GSM, GPRS, 3G, WCDMA or WiMAX, but a different communication protocol than the communication protocols used by the first and second inbound data packets and the first and second outbound data packets.

In this embodiment, the data link layer circuit 100 includes a first media controller 110, a bridge module 120, a second media controller 130, and a third media controller 140. The first media controller 110 is connected to the first communication port 210 and is used for receiving the first inbound data packets from, and transmitting the first outbound data packets to the first communication port 210. The second media controller 110 is connected to the second communication port 220 and is used for receiving the second inbound data packets from, and transmitting the second outbound data packets to the second communication port 220. The third media controller 140 is connected to the third communication port 230 and is used for receiving the third inbound data packets from, and transmitting the third outbound data packets to the third communication port 230.

The bridge module 120 is connected to the first media controller 110, the second media controller 130, and the third media controller 140, and includes a flow controller 122 and a data converter 124. The flow controller 122 is used for controlling data packet flow between the WLAN 20 and the WWANs 30 and 40 and recording current bandwidths and utilization statuses of the WWANs 30 and 40. The data converter 124 is used for converting the first inbound data packets from the WLAN 20 to one of the second outbound data packets and the third outbound data packets and converting the second inbound data packets or the third inbound data packets from the WWANs 30 or 40 to the first outbound data packets. In one embodiment, the data converter 124 may be a data packet form converting circuit configured for determining data packet forms, converting heads of data packets, and thereby converting forms of the data packets.

In one embodiment, the second communication port 220 is further used for detecting and sending the current bandwidth and utilization status of the first WWAN 30 to the flow controller 122 via the second media controller 130. The third communication port 230 is further used for detecting and sending the current bandwidth and utilization status of the second WWAN 40 to the flow controller 122 via the third media controller 140. The flow controller 122 is further used for determining priorities of the WWANs 30 and 40 according to the current bandwidths and utilization statuses of the WWANs 30 and 40. In this embodiment, the flow controller 122 determines bandwidth per person accessing the WWANs 30 and 40 according to the current bandwidths and utilization statuses of the WWANs 30 and 40. Accordingly, the flow controller 122 sets the WWAN having a higher bandwidth per person having a higher priority, and the WWAN having a lower bandwidth per person having a lower priority. It may be appreciated that the flow controller 122 may set priorities of the WWANs 30 and 40 according to other rules. The data converter 124 converts the first inbound data packets to data packets consistent with the WWAN having the highest priority.

For instance, if the bandwidth of the first WWAN 30 is 4 bits per second (bps) with four subscribers on-line, and the bandwidth of the second WWAN 40 is 3 bps with two subscribers on-line, the bandwidth per person of the first WWAN 30 is 1 bps, and the bandwidth per person of the second WWAN 40 is 1.5 bps. Therefore, the flow controller 122 gives the second WWAN 40 a higher priority than the first WWAN 30. The data converter 124 converts the inbound data packets to the third outbound data packets and sends the third outbound data packets to the third media controller 140 to send to the second WWAN 40 via the third communication port 230.

The flow controller 122 is further used for determining flow directions of data packets according to destination addresses of the data packets. If data packets are transmitted from the first media controller 110 to the second media controller 130 or the third media controller 140, the flow controller 122 makes the data converter 124 convert the data packets to outbound data packets consistent with the WWAN having the highest priority and sending the outbound data packets to a corresponding media controller. However, if data packets are transmitted from the second media controller 130 or the third media controller 140 to the first media controller 110, the flow controller 120 makes the data converter 124 convert the data packets to first outbound data packets and send the first outbound data packets to the first media controller 110. If the flow controller 122 determines the data packets are transmitted from the first media controller 110 to the first media controller 110, that is, the mobile terminals 12 communicate with each other in the WLAN 20, the data converter 124 does not work and the bridge device 10 only acts as an AP in the WLAN 20.

In this embodiment, the data link layer circuit 100 further includes a memory 150. The memory 150 is connected to the bridge module 120 and includes a first memory 152 and a second memory 154. The first memory 152 is used for storing operation programs of the bridge module 120, and the second memory 154 is used for temporarily storing the first, second and third inbound and outbound data packets that need to be converted.

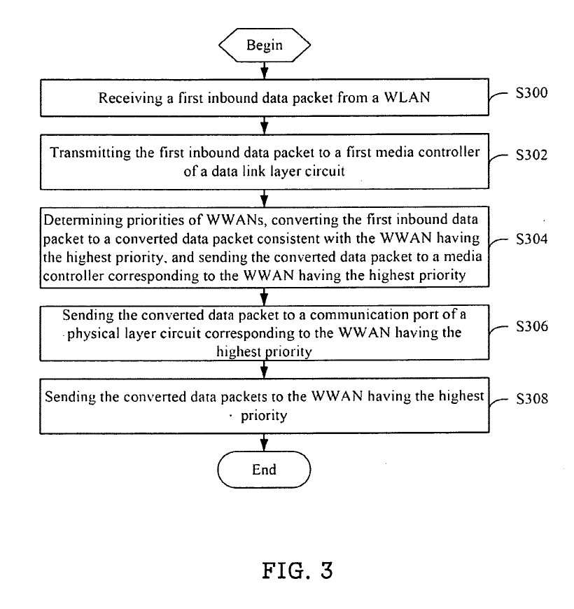

FIG. 3 is a flowchart illustrating a first embodiment of a method for bridging a WLAN to a WWAN. Depending on the embodiment, certain of the blocks described below may be removed, others may be added, and the sequence of blocks may be altered. In the first embodiment, the mobile terminals 12 need to connect to the Internet 50 or communicate with mobile terminals in the WWANs 30 and 40, and data packets are transmitted from the WLAN 20 to the WWANs 30 and 40. In block S300, the first communication port 210 receives a first inbound data packet from the WLAN 20. Continuing to block S302, the first communication port 210 transmits the first inbound data packet to the first media controller 110 of the data link layer circuit 100. Moving to block S304, the flow controller 122 determines priorities of the WWANs 30 and 40, and the data converter 124 converts the first inbound data packet to a converted data packet consistent with the WWAN having the highest priority and sends the converted data packet to a media controller corresponding to the WWAN having the highest priority. Continuing to block S306, the corresponding media controller sends the converted data packet to a communication port of the physical layer circuit 200 corresponding to the WWAN having the highest priority. Moving to block S308, the corresponding communication port sends the converted data packets to the WWAN having the highest priority. Thus, the mobile terminals 12 can connect to the Internet 50 via the WLAN 20 and the WWANs 30 and 40 or communicate with mobile terminals in the WWANs 30 and 40.

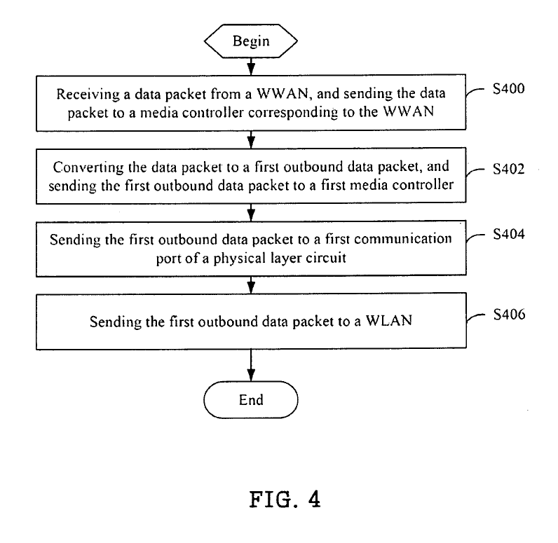

FIG. 4 is a flowchart illustrating a second embodiment of a method for bridging a WLAN to a WWAN. In the second embodiment, data packets are transmitted from the WWANs 30 or 40 to the WLAN 20. In block S400, the physical layer circuit 200 receives a data packet from one of the WWANs 30 and sends the data packet to a media controller corresponding to the one of the WWANs 30 and 40. Continuing to block S402, the data converter 124 converts the data packet to a first outbound data packet and sends the first outbound data packet to the first media controller 110. In block S404, the first media controller 110 sends the first outbound data packet to the first communication port 210 of the physical layer circuit 200. Moving to block S406, the first communication port 210 sends the first outbound data packet to the WLAN 20. Thus, data packets are transmitted from the WWANs 30 and 40 to the WLAN 20.

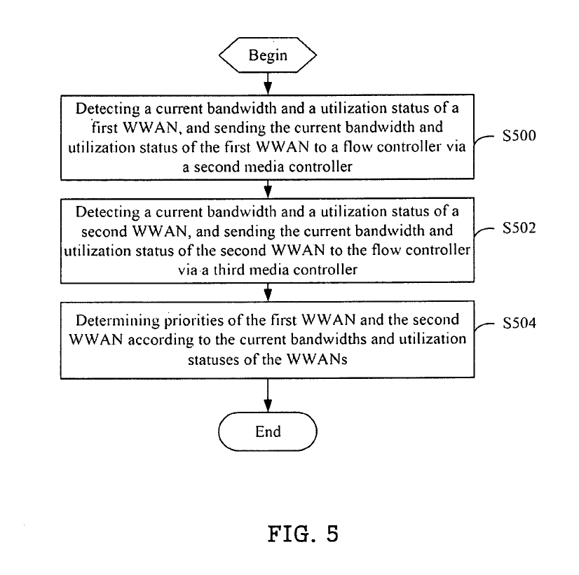

FIG. 5 is a flowchart illustrating a third embodiment of a method for bridging a WLAN to a WWAN. In block S500, the second communication port 220 detects a current bandwidth and a utilization status of the first WWAN 30 and sends the current bandwidth and utilization status of the first WWAN 30 to the flow controller 122 via the second media controller 130. Continuing to block S502, the third communication port 230 detects a current bandwidth and a utilization status of the second WWAN 40 and sends the current bandwidth and utilization status of the second WWAN 40 to the flow controller 122 via the third media controller 140. In one embodiment, sequences of blocks S500 and S502 may be altered or at the same time. Moving to block S504, the flow controller 122 determines priorities of the WWANs 30 and 40 according to the current bandwidths and utilization statuses of the WWANs 30 and 40. In a practical embodiment, the flow controller 122 determines bandwidths per person of the WWANs 30 and 40 according to the current bandwidths and utilization statuses of the WWANs 30 and 40, and sets the WWAN having a higher bandwidth per person having a higher priority and the WWAN having a lower bandwidth per person having a lower priority. It may be appreciated that the flow controller 122 may set priorities of the WWANs 30 and 40 according to other rules.

The bridge device 10 and the method for bridging WLAN and WWAN convert forms of data packets in the data link layer circuit 100, which achieves easy connections of the WLAN 20 and the WWANs 30 and 40 only by an additional electronic device without changing existing communication structures or setting new communication structures. In addition, the bridge device 10 connecting WWANs 30 and 40 can make sure bandwidth of subscribers and reduces risk of lower bandwidth.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A bridge device for bridging a wireless local area network (WLAN) to a plurality of wireless wide area networks (WWANs), comprising:
a first communication port used for receiving first inbound data packets from, and transmitting first outbound data packets to the WLAN;
a second communication port used for receiving second inbound data packets from, and transmitting second outbound data packets to a first WWAN;
a third communication port used for receiving third inbound data packets from, and transmitting third outbound data packets to a second WWAN;
a first media controller used for receiving the first inbound data packets from, and transmitting the first outbound data packets to the first communication port;
a second media controller used for receiving the second inbound data packets from, and transmitting the second outbound data packets to the second communication port;
a third media controller used for receiving the third inbound data packets from, and transmitting the third outbound data packets to the third communication port; and
a bridge module, comprising:
a flow controller used for controlling data packet flow between the WLAN and the first and second WWANs, and for recording current bandwidths and utilization statuses of the first and second WWANs; and
a data converter used for converting the first inbound data packets to one of the second outbound data packets and the third outbound data packets according to the current bandwidths and utilization statuses of the first and second WWANs, and for converting the second inbound data packets and the third inbound data packets to the first outbound data packets.

2. The bridge device of claim 1, wherein the second communication port is further used for detecting the current bandwidth and utilization status of the first WWAN and sending the current bandwidth and utilization status of the first WWAN to the flow controller via the second media controller.

3. The bridge device of claim 2, wherein the third communication port is further used for detecting the current bandwidth and utilization status of the second WWAN and sending the current bandwidth and utilization status of the second WWAN to the flow controller via the third media controller.

4. The bridge device of claim 3, wherein the flow controller is further used for determining priorities of the first and second WWANs according to the current bandwidths and utilization statuses of the first and second WWANs.

5. The bridge device of claim 4, wherein the data converter is further used for converting the first inbound data packets to outbound data packets corresponding to a WWAN having the highest priority according to the priorities of the first and second WWANs.

6. The bridge device of claim 1, further comprising a memory comprising a first memory for storing operation programs of the bridge module, and a second memory for temporarily storing the first, second and third inbound and outbound data packets.

7. The bridge device of claim 1, wherein the data converter comprises a data packet form converting circuit for determining data packet forms, converting heads of the data packets to convert forms of the data packets.

8. The bridge device of claim 1, wherein the first inbound data packets and the first outbound data packets both use the IEEE 802.11a/b/g protocol.

9. The bridge device of claim 1, wherein the second inbound data packets and the second outbound data packets both use a communication protocol selected from the group consisting of Global System for Mobile Communications (GSM), General Data Packet Radio Service (GPRS), third generation (3G), wideband code division multiple access (WCDMA) and Worldwide Interoperability for Microwave Access (WiMAX).

10. The bridge device of claim 9, wherein the third inbound data packets and the third outbound data packets both use a communication protocol selected from the group consisting of GSM, GPRS, 3G, WCDMA and WiMAX, but a different communication protocol than the communication protocol used by the second inbound data packets and the second outbound data packets.

11. A method for bridging a wireless local area network (WLAN) to a wireless wide area network (WWAN), for transmitting data packets between a WLAN and a plurality of WWANs, comprising:
receiving a first inbound data packet from the WLAN, and transmitting the first inbound data packet to a first media controller;
determining priorities of the plurality of WWANs, and converting the first inbound data packet to an outbound data packet consistent with a WWAN having the highest priority;
transmitting the outbound data packet to a media controller corresponding to the WWAN having the highest priority;
transmitting the outbound data packet to a communication port corresponding to the WWAN having the highest priority; and
transmitting the outbound data packet to the WWAN having the highest priority.

12. The method for bridging a WLAN to a WWAN of claim 11, wherein the block of determining priorities of the plurality of WWANs comprises:
detecting a current bandwidth and a utilization status of a first WWAN of the plurality of WWANs, and sending the current bandwidth and utilization status of the first WWAN to a flow controller via a second media controller;
detecting a current bandwidth and a utilization status of a second WWAN of the plurality of WWANs, and sending the current bandwidth and utilization status of the second WWAN to the flow controller via a third media controller; and
determining the priorities of the first and second WWANs according to the current bandwidths and utilization statuses of the first and second WWANs.

13. The method for bridging a WLAN to a WWAN of claim 11, further comprising:
receiving an inbound data packet from one of the plurality of WWANs;
transmitting the inbound data packet to a media controller corresponding to the one of the plurality of WWANs;
converting the inbound data packet to a first outbound data packet having the same communication protocol as the first inbound data packet;
transmitting the first outbound data packet to the first media controller;
transmitting the first outbound data packet to a first communication port corresponding to the WLAN; and
transmitting the first outbound data packet to the WLAN.

14. The method for bridging a WLAN to a WWAN of claim 13, wherein the first inbound data packet and the first outbound data packet both use the IEEE 802.11 a/b/g protocol.

15. The method for bridging a WLAN to a WWAN of claim 13, wherein the inbound data packet from the plurality of WWANs and the outbound data packet to the plurality of WWANs both use a communication protocol selected from the group consisting of Global System for Mobile Communications (GSM), General Packet Radio Service (GPRS), third generation (3G), wideband code division multiple access (WCDMA), and Worldwide Interoperability for Microwave Access (WiMAX), wherein different WWANs have different communication protocols.
